(19) United States
(12) Patent Application Publication
(10) Pub. No.: US 2005/0073429 A1
(43) Pub. Date: Apr. 7, 2005

(54) Remote controlled power switch

(76) Inventor: Steve Sevak Singh, Brighton (GB)

Correspondence Address: Dr Steve Sevak Singh, 17 Southdown Road, Brighton East Sussex, BN1 6FH, GB

(21) Appl. No.: 10/502,568

(22) PCT Filed: Feb. 13, 2003
(86) PCT No.: PCT/GB03/00654

(30) Foreign Application Priority Data
Feb. 13, 2002 (GB) 0203388.4

(51) Int. Cl. G08C 19/00; G05B 19/02

(52) U.S. Cl. 340/825.22; 340/825.72; 340/310.01; 315/291

(57) ABSTRACT

The present invention discloses a system for remotely controlling a light. In the preferred embodiment, a standard remote control is used to turn a light level to a performance setting. The system has means for receiving (62), learning (64), locking and unlocking (66) the learning mode as well as a means to control (68). Importantly the standard remote control is used to configure the system, locking the device in and out of a learning mode as well as to control. This makes it possible for the device to be out of reach of the user with no need for a manual user interface. The invention does not require isolation for configuring the system which reduces cost and complexity and has safety advantages in certain cases. In the locked mode the device becomes highly immune from corruption such as infrared ‘noise’ and secure from being controlled inadvertently.

The present invention relates generally to a remote controlled function of a device and more particularly to a power switch which enables a user to remotely control a light or other electrical system using a conventional remote control.

### BACKGROUND OF THE INVENTION

It will be appreciated by those in the art that infrared remotes are commonly used to control household appliances such as televisions, VCRs, stereos, and the like.

Attempts to remotely control a light or other electrical device are disclosed in patents such as U.S. Pat. Nos. 6,163,275; 4,935,733; 4,712,105; and 5,099,193. Unfortunately, these patents suffer from common problems, they are an expensive and complicated means of configuring and isolating the system. In cases, requiring a manual user interface.

What is needed, then, is a way that does not necessitate an independent user interface and isolation for configuring a system. The system that is needed must be capable of learning the configuration for controlling the system using the same general interface used by the conventional remote control to control the function of the light or other electrical system. Also the system configuration must be able to be locked so that the system is immune from corruption and secure from being inadvertantly changed.

The device will be economical to manufacture without the need for isolation, undue cost and complication of a user interface for configuring the system. This is also of particular value when the controlling device is out of reach of the user and for safety reasons must not come into contact with the user. This system is presently lacking in the prior art.

### SUMMARY OF THE INVENTION

The present invention discloses a system for controlling power to an electrical load using a standard remote control. In the preferred embodiment, a conventional remote control is used to adjust a light or other electrical equipment to performance settings.

A learning mode is provided which allows a signal when pressing a button on a standard remote to be learned. Thereafter recognition of the button as a remote control function key will occur when it is pressed. Thereafter remote control function key is used to configure the system and or control it. Further signals from the remote control function key, when the button is pressed from the standard remote, will adjust the power to the light or electrical equipment thereby changing the light level of the light or performance setting of the electrical equipment.

A locking and unlocking mode, which, when locked prevents the recognition of the button as a remote control function key from being corrupted and secures it from being inadvertantly changed so that electrical equipment is immune from the effects of infrared ‘noise’. The same remote interface used by the conventional remote control to remotely control the function of the light or other electrical equipment is used to lock and unlock the learning mode. When the remote control function key is pressed for defined time intervals the learning mode will be locked or unlocked. When the learning mode is locked the recognition of a button as a remote control function key can not occur. To unlock the mode the remote control function key is pressed for a further defined time interval. The present invention has a remote controlled switch which has a line interface electrically connected with a power supply. The power supply electrically connects to an infrared sensor and processor.

Accordingly, one object of the present invention is to provide a remotely controlled switch for controlling a light which can be configured and operated by a standard remote control.

Another object of the present invention is to provide a remote switch which is capable of learning without a separate user interface.

Another object of the present invention is to provide a means for both controlling and configuring a system remotely.

Another object of the present invention is to provide a means for both controlling and configuring a system through the same remote interface.

Another object of the present invention is to eliminate the need for undue user interface and user isolation.

Another object of the present invention is to provide a means of locking and unlocking the means for learning.

Another object of the present invention is to provide a system which is economical and easily to manufacture.

### BRIEF DESCRIPTION OF DRAWINGS

FIG. 1. Is a perspective view of a standard Infra-red remote control and a wall mounted wired-in preferred device for controlling the light level of a Pendant light fitting.

FIG. 2. Is a block diagram of the preferred device of the present invention.

FIG. 3. Is a schematic of the preferred device of the present invention.

FIG. 4. Is a block diagram of the present invention indicating some basic features.

FIG. 5. Is a block diagram of the preferred device of the present invention indicating some basic features.

FIG. 6. Is a perspective view of a standard Infra-red remote control and a rose mounted wired-in device for controlling the light level of a Pendant light fitting.

FIG. 7. Is a perspective view of a standard Infra-red remote control and an in-line wired-in device for controlling the light level of a Pendant light fitting.

FIG. 8. Is a perspective view of a standard Infra-red remote control and an in-line adapter for controlling the light level of a Pendant light fitting.

FIG. 9. Is a block diagram of the device of the present invention shown in the perspective views of FIG. 6, FIG. 7 and FIG. 8.

FIG. 10. Is a perspective view of a standard Infra-red remote control and an in-line wired-in device for controlling the speed of a celling fan.

### DESCRIPTION OF THE PREFERRED EMBODIMENT

In FIG. 1 it is shown generally at 10 a wired-in device of the present invention. The device 10 is capable of controlling the light level of a pendant light fitting 12 which is fitted with a bulb 16 and powerd from the ‘power out’ lead 30 of the wired-in device of the present invention 10.

Preferably the wall mounted wired-in device 10 is furnashed with a mounting plate 14 to enable it to be fixed to the wall 20. The device 10 has a power ON/OFF switch 18 and an infrared sensor 22 which senses infrared signals 28 from a standard infrared remote control 26. The standard infrared remote control 26 commonly has infrared signal activation buttons 32 which can be recognised by the device 10 to become remote control function keys for device 10. The device 10 electrically links and controls power between ‘power in’ lead 24 and ‘power out’ lead 30 which is connected to the pendant light fitting 12. The pendant light fitting 12 can be any other type of light fitting such as a wall light or any other electrical device such as a celling fan.

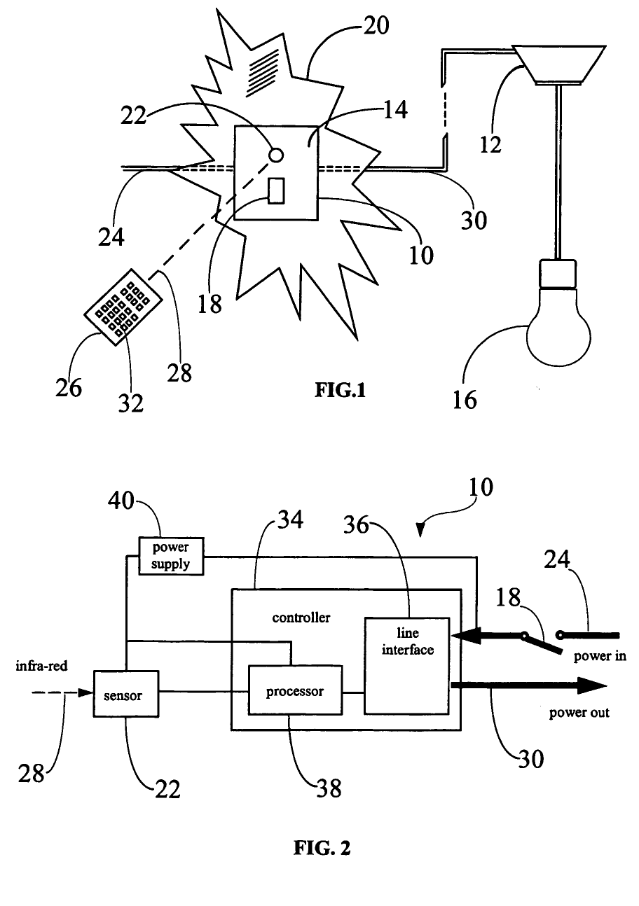

In FIG. 2 there is shown generally at 10 the block diagram of the present invention. Power is delivered to the device 10 through the ‘power in’ lead 24. A device power switch 18 allows power into the device line interface 36 which along with the processor, 38 has a controlling influence on the power delivered to the ‘power out’ lead 30. The processor 38 and line interface 36 form the basis of the controller 34 of the device 10. Power is taken after the switched power line 24 and diverted to the power supply 40. The power supply 40 regulates power to the sensor 22 and processor 38. An infrared signal 28 is sensed by the sensor 22. The processor recieves information from the sensor 22 and communicates with the line interface 36. In communicating with the line interface 36 the processor is able to control the amount of power directed to the power out line 30 via the line interface 36.

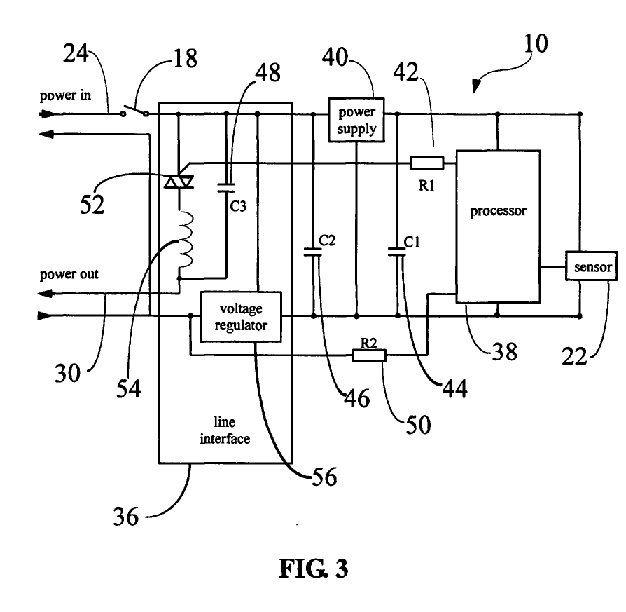

In FIG. 3 there is shown generally at 10 the schematic of the device of the present invention. Power is delivered to the device 10 through the ‘power in’ lead 24. A device power switch 18 allows power into the device line interface 36 which includes a triac 52, suppression inductor 54 and supression capacitor 48. The line interface also includes a voltage regulator 56 which is constructed from components such as rectifier diodes, voltage clamping zener diodes, power coupling capacitors and power current limiting resistors. The capacitor 46 and 44 are charge storage capacitors for the input and output respectively of the power supply 40. The resistor 42 acts as the drive limiting resistor for the triac 52 and the resistor 50 supports a phase detector signal to the processor 38. Phase information detected by the processor 38 is used by the processor to perform phase controlled firing of the triac 52. The processor 38 includes all ansilary components such as crystals, resistors, various capacitors to set the clock cycle time etc. Phase control firing of the triac 52 is the means by which the processor is able to control the power out to the power out lead 30.

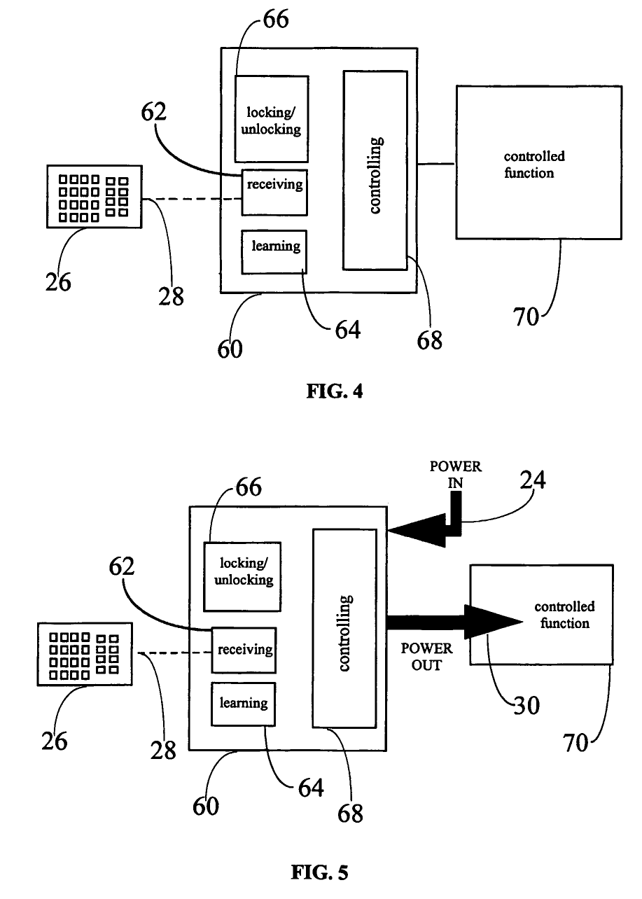

In FIG. 4 there is shown a standard remote control 26, and its infrared signal 28 communicating with the means of receiving 62 of the basic “features block” 60 of the device of the present invention. The “features block” 60 also has means for learning 64, means for locking/unlocking 66, and means for controlling 68. the means for controlling 68 and is capable of activating the controlled function 70 of an electrical system.

When power is applied to the device of the present invention, the means for learning 64 is evoked only if the means for receiving 62 is in reciept of an infrared signal 28 within a defined time interval and the learning mode is in the unlocked state. If the means for learning is evoked, the “features block” 60 is able to recognise the infrared signal 28 as a remote control function signal. Thereafter if the means for receiving is in reciept of a remote control function signal, the means for controlling 68 activates the controlled function 70 causing change in the performance setting of the electrical system over which the controlled function 70 has influence.

If the learned remote control function signal is received for a defined time interval the means for locking/unlocking 66 is evoked in the “features block” 60. Whenever the learning mode is locked in this manner, the means for learning 64 is inhibited even when power is applied to the device of the present invention and means for receiving 62 is in reciept of any infrared signal 28 within a any time interval. Recognition of an infrared signal 28 as a remote control function signal can only occur after the remote control function signal is received for a further defined time interval thereby unlocking the means for learning 64.

In FIG. 5 there is shown a standard remote control 26, and its infrared signal 28 communicating with the means of receiving 62 of the basic “features block” 60 of the device of the present invention. The “features block” 60 also has means for learning 64, means for locking/unlocking 66, means for controlling 68 and a feed, power in 24. In this preferred device of the present invention the means for controlling 68 is capable of initiating the controlled function 70 which is power control to an electrical system.

When power is turned on to the preferred device of the present invention, the means for learning 64 is evoked, if the means for receiving is in reciept of an infrared signal 28 within a defined time interval and the learning mode is the unlocked state. If the means for learning is evoked, the “features block” 60 recognises the infrared signal 28 as a remote control function signal. Thereafter if the means for receiving 62 is in reciept of a remote control function signal, the means for controlling 68 causes a change in the power out 30 which is the controlled function 70 of the electrical system.

If the learned remote control function signal is received for a defined time interval the means for locking/unlocking 66 is evoked in the “features block 60. Whenever the learning mode is locked in this manner, the means for learning 64 is inhibited even when power is applied to the preferred device of the present invention and means for receiving 64 is in reciept of any infrared signal 28 within any time interval. Recognition of an infrared signal 28 as a remote control function signal can only occur after the remote control function signal is received for a further defined time interval thereby unlocking the means for learning 64.

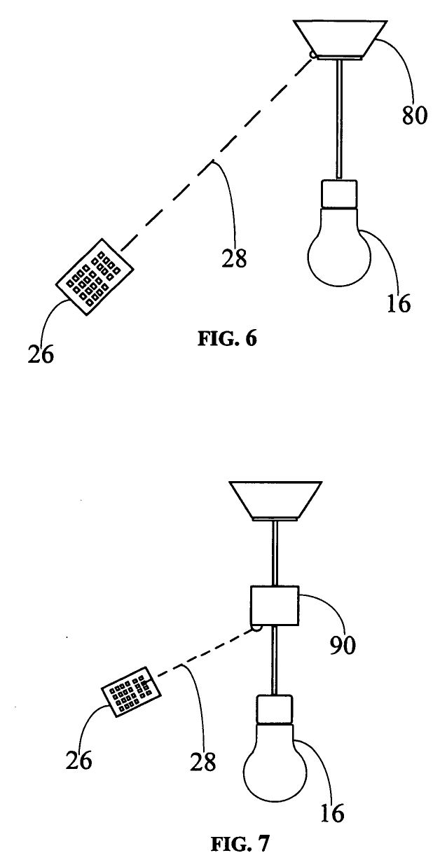

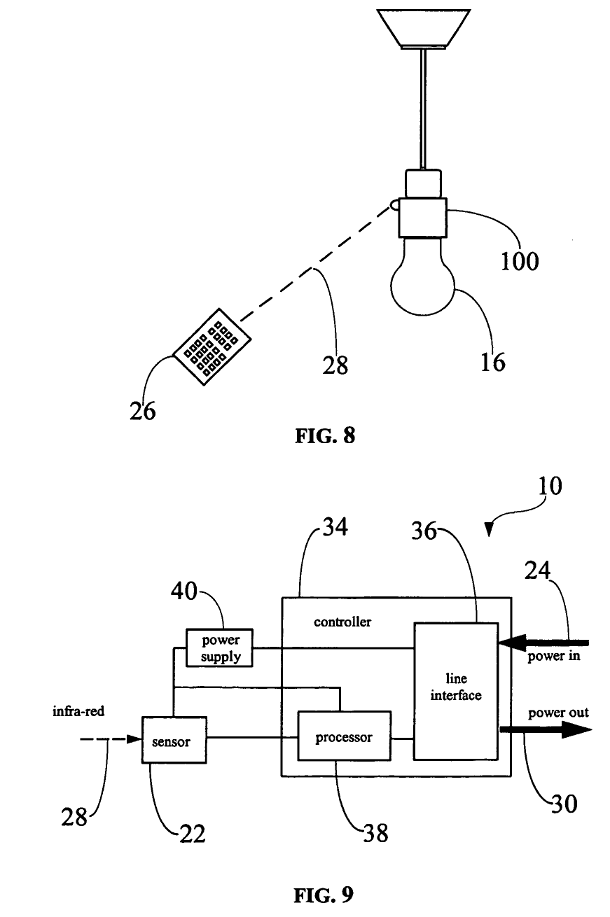

In each of the diagrams FIG. 6, FIG. 7. and FIG. 8 there is shown a standard remote control 26, infrared signal 28 and bulb 16. Shown in FIG. 9 is the block diagram of the device of the present invention for the embodiments 80, 90 and 100 of FIG. 6, FIG. 7. and FIG. 8 respectively. The embodiments 80, 90 and 100 are examples which have a common representation block diagram FIG. 9 excluding a device ON/OFF power switch 18 like the one shown in FIG. 2.

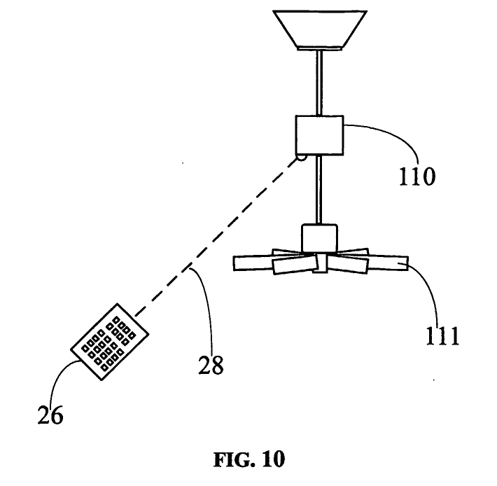

In FIG. 10 is shown a perspective view of a standard infra-red remote control 26, infrared signal 28 and a wired-in, in-line device 110 for controlling the speed of a celling fan 111. The controlled electrical device being the celling fan and embodiment of the present invention being the wired-in in-line device 110.

1. A device for controlling a function of an electrical device using a conventional remote control comprising:
a. Means for controlling said function of said electrical device;
b. Means for receiving a signal from said conventional remote control;
c. Means for learning an operating key from said conventional remote control, said controlling means responsive to reception by said receiving means of a signal corresponding to said learned operating key;
d. Means of locking and unlocking means for learning an operating key from said conventional remote control through means for receiving a signal from said conventional remote control.

2. The device of claim 1 further comprising means for adjusting power to said electrical device.

3. The device of claim 1 wherein said means for controlling amount of power to said electrical device comprises a line interface.

4. The device of claim 1 wherein said means for receiving a signal from said conventional remote control comprises a sensor.

5. The device of claim 1 wherein said means for learning an operating key from said conventional remote control device such that said device will accept instructions from a particular remote control.

6. A device for operating a light using a conventional remote control comprising;
a. A line interface for interfacing between a switch power source (and a light load) and a light power source.
b. A power supply electrically connected to said line interface;
c. A sensor for receiving a signal from said conventional remote control electrically connected to said power supply;
d. A processor electrically connected to said power supply and said sensor for processing said signal and said power, said processor reading input from said conventional remote control to learn an operating key of said remote control;
e. Controller electrically connected to said processor and said line interface for controlling power passed through said line interface, said controller responsive to signal from processor responsive to reception by said sensor of a signal corresponding to said learned operating key:
f. Said processor locked and unlocked from learning of an operating key in response to operating key operated for a defined time interval.
